(19) United States
(12) Patent Application Publication
(10) Pub. No.: US 2021/0241297 A1
(43) Pub. Date: Aug. 5, 2021

(54) Artificial Intelligence Sales Technology Stack Prospecting

(71) Applicant: Dell Products L.P., Round Rock, TX (US)

(72) Inventor: Venkata Chandra Sekar Rao, Bengaluru (IN)

(73) Assignee: Dell Products L.P., Round Rock, TX (US)

(21) Appl. No.: 16/780,276

(22) Filed: Feb. 3, 2020

(51) Int. Cl. G06Q 30/02; G06N 3/04

(52) U.S. Cl. CPC G06Q 30/0204; G06N 3/0445

(57) ABSTRACT

A system, method, and computer-readable medium for performing artificial intelligence (AI) to enhance productivity and efficiency of a sales process by identifying prospective customers by a proactive approach. Stacked recurring neural networks are implemented to classify existing and prospective customers, and to learn and determine sales processes and sales pipelines. Sales patterns of existing customers are identified. Based on the sales patterns, classification is performed as to customers. Prospective customers are identified based on the sales patterns. A recommendation is made as to which prospective customers to target. Sales process and sales pipeline of prospective customers are determined to allow for proactive actions to be performed in the sales process and sales pipeline.

### BACKGROUND OF THE INVENTION

### Field of the Invention

The present invention relates to information processing systems. More specifically, embodiments of the invention provide a system, method, and computer-readable medium for performing artificial intelligence (AI) to enhance productivity and efficiency of a sales process by identifying prospective customers by a proactive approach.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Product and/or service sales involves considerable intuitive and learned skills by salespeople who have acquired considerable experience and skills over time. A good salesperson has the knowledge to understand and evaluate customers and their buying and purchasing habits and has the ability to make expeditious sales. Customer buying decisions are typically not based on well defined logic. In sales, factors such as emotion, trust, communication skills, culture and intuition play a big role. Often times, salespeople can spend considerable time and resources in unproductive sales prospecting. Salespeople can struggle with prioritizing, qualifying, and gathering productive sales leads.

### SUMMARY OF THE INVENTION

A system, method, and computer-readable medium are disclosed for performing artificial intelligence (AI) to enhance productivity and efficiency of a sales process by identifying prospective customers by a proactive approach. The sales patterns of existing customers are identified. Based on the sales patterns, classification is performed as to customers. Prospective customers are identified based on the sales patterns. A recommendation is made as to which prospective customers to target. Sales process and sales pipeline of prospective customers are determined to allow for proactive actions to be performed in the sales process and sales pipeline.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a block diagram of an Artificial Intelligence (AI) sales technology stack prospecting environment;

FIG. 3 is a block diagram of a customer recurring neural network (RNN);

FIG. 4 are block diagrams of sales process and a sales pipeline;

FIG. 5 is a block diagram of long short term memory (LSTM) cell of an LSTM recurring neural network (RNN);

FIG. 6 are block sales pipeline and process as determined by a long short term memory (LSTM) recurring neural network (RNN); and

FIG. 7 is a generalized flowchart for performance of operations implemented in accordance with an embodiment of the invention for artificial intelligence (AI) sales technology stack prospecting.

### DETAILED DESCRIPTION

A system, method, and computer-readable medium are disclosed for performing artificial intelligence (AI) to enhance productivity and efficiency of a sales process by identifying prospective customers by a proactive approach. Patterns of the existing customers are observed and learned by receiving data/information of the existing customers through a recurring neural network (RNN). The RNN is part of a training model which is used to form or determine actions of prospective customers. In particular, determination is made as to what actions in a sales process, prospective customers would take to become actual customers. Another RNN, and particularly a long short-term memory (LSTM) artificial recurrent neural network (RNN) is used to create a customized process and pipeline of actions prospective customers would take to become actual customers. Therefore, stacked artificial intelligence neural networks in the form of a first RNN and a second RNN are implemented for a sales prospecting process, or artificial intelligence sales technology stack prospecting.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

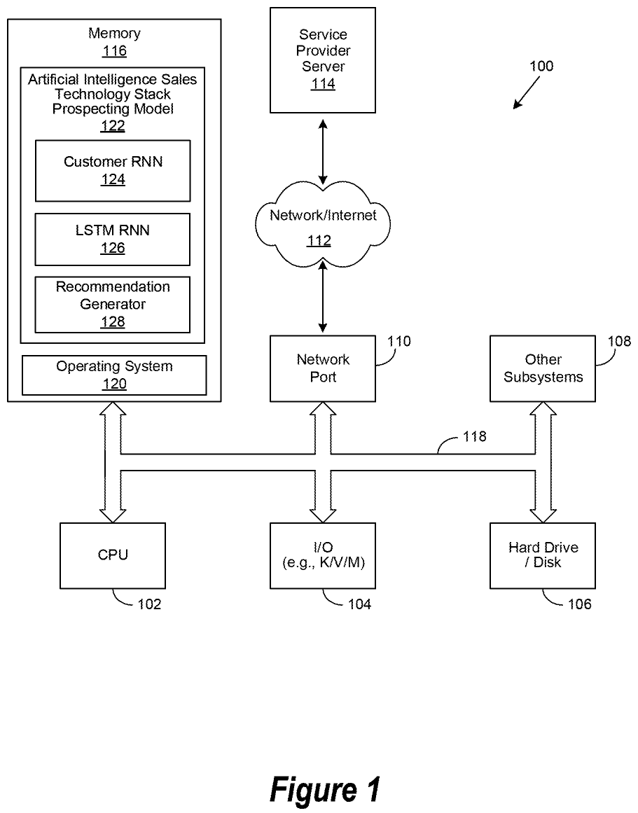

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 112, which is likewise accessible by a service provider (business/company) server 114. The network 112 may be a public network, such as the Internet, a physical private network, a wireless network, a virtual private network (VPN), or any combination thereof. Skilled practitioners of the art will recognize that many such embodiments are possible, and the foregoing is not intended to limit the spirit, scope or intent of the invention.

The information handling system 100 likewise includes system memory 116, which is interconnected to the foregoing via one or more buses 118. System memory 116 further includes an operating system (OS) 120 and in various embodiments includes an artificial intelligence (AI) sales technology stack prospecting model 122. In certain implementations, the artificial intelligence (AI) sales technology stack prospecting model 122 includes a customer recurrent neural network (RNN) 124, which receives existing customer data or information. In particular, the customer recurrent neural network (RNN) 124 receives feature based questions based on existing customer data or information and determines and classifies as to time to convert to actual customers. The customer recurrent neural network (RNN) 124 is further described below. In certain implementations, the artificial intelligence (AI) sales technology stack prospecting model 122 includes a long short-term memory (LSTM) artificial recurrent neural network (RNN) or LSTM RNN 126, which is used to create the customized process and pipeline as to prospective customers and supports a sales prospecting process. LSTM RNN 126 is further discussed below. Customer RNN 124 is stacked with LSTM RNN 126.

In certain implementations, the artificial intelligence (AI) sales technology stack prospecting model 122 includes a recommendation generator 128. The recommendation engine 128 particularly provides recommendation as to prospective customers and provides process and pipeline of actions as to prospective customers as determined by the LSTM RNN 126.

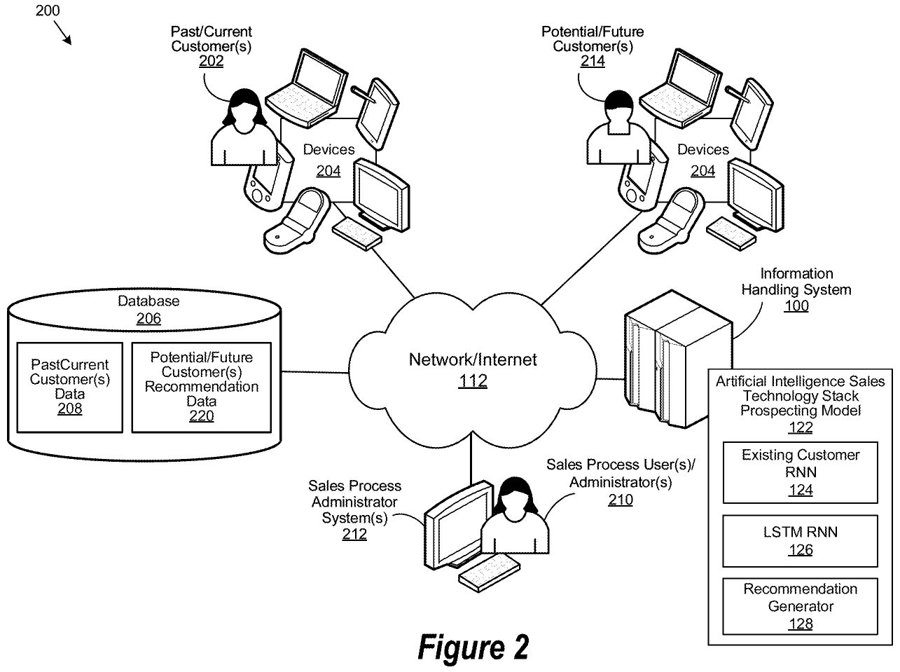

FIG. 2 is an Artificial Intelligence (AI) sales technology stack prospecting environment. In certain embodiments, as described above, the information handling system 100 includes the artificial intelligence (AI) sales technology stack prospecting model 122 and is connected to the network 112. In certain embodiments, the information handling system 100, and particularly the AI sales technology stack prospecting model 122 through network 112 is connected to one or more past or current customers 202. Past or current customers 202 connect to the network 112 though devices 204. Devices 204 refer to an information handling system such as a personal computer, a laptop computer, a tablet computer, a personal digital assistant (PDA), a smart phone, a mobile telephone, or other device that is capable of communicating and processing data. In particular, data or information related to sales process events regarding the past or current customers 202 are provided. In certain implementations, such data or information is stored in a database 206 as past/current customer(s) data 208.

Certain implementations provide for sales process user(s) or administrator(s) 210 to access and use the AI sales technology stack prospecting model 122. In particular administrator(s) 210 through sales process administrator system(s) 212 access and use AI sales technology stack prospecting model 122. The sales administrator system(s) 212 can instruct AI sales technology stack prospecting model 122 to extract and process data and information from past or current customers 202 through devices 204 as to sales process actions previously taken by past or current customers. Such actions are related to feature based questions that are provided to the customer RNN 124 as described in FIG. 1. The customer RNN 124 provides target output that classifies past or current customer(s) 202 as to time taken to convert from potential customer to actual customer.

In certain implementations, the sales administrator system(s) 212 can instruct AI sales technology stack prospecting model 122 to form sales process actions specific to potential or future customers 214. Potential or future customers 214 connect to the network 112 though devices 216. Devices 216 refer to an information handling system such as a personal computer, a laptop computer, a tablet computer, a personal digital assistant (PDA), a smart phone, a mobile telephone, or other device that is capable of communicating and processing data. In particular, data or information related to characteristics of the potential or future customer(s) 214 are provided. In certain implementations, such characteristics can be extracted from actions taken by potential or future customer(s) 214 performed at other sources 218, such as websites. For example, a potential or future customer(s) 214 may access or inquire as to product or service provided by the business entity of the sales process user(s) or administrator(s) 210. Any actions or characteristics related to the sales process can be provided directly or indirectly by potential or future customer(s) 214.

Such characteristics are used by the LSTM RNN 126 to form sales actions process(es) and pipeline(s) for specific potential or future customer(s) 214. In particular, the sales actions process(es) and pipeline(s) provide what actions in the sales process should be taken to make potential customers into actual customers and predict times as to when such potential customers may become actual customers. The recommendation generator 128 provides the potential customer process and pipeline to the sales process administrator system(s) 212, allowing the sales process user(s) or administrator(s) 210 to determine likelihood of converting potential customers to actual customers, actions to take in the sales process, and the expected time to convert to actual customers. In certain implementations, the process(es) and pipeline(s) of specific potential or future customer(s) 214 is stored as potential/future customer(s) recommendation data 220 in database 206. In certain implementations, data or information related to characteristics of the potential or future customer(s) 214 are also stored in data 220.

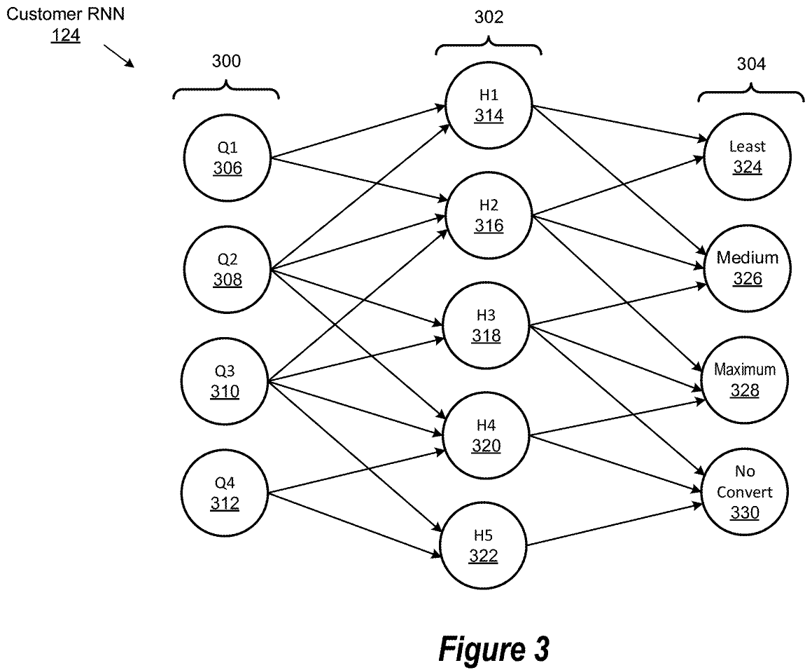

FIG. 3 is a block diagram of an example customer RNN 124. RNN 124 is implemented as part of training of the AI sales technology stack prospecting model 122. The customer RNN 124 is a fully connected neural network classifier to understand the sales process patterns of customers using data or information of past or current customers 202.

In this example, the customer RNN 124 includes an input layer 300, where input layer 300 includes feature based questions. Customer RNN 124 includes hidden layers 302, where the hidden layers 302 process the questions from input layer 300. Customer RNN 124 further includes an output or target layer 304. In this example, the target layer 304 is made of various time classifications that classify customers as to patterns of sales actions.

RNN 124 receives feature based questions. In this example, four questions Q1 306, Q2 308, Q3 310, and Q4 312 are illustrated. It is to be understood that RNN 124 can receive fewer or more questions. Each of questions Q1 306, Q2 308, Q3 310, and Q4 312 include particular features as to existing customers, and in certain implementations features as to potential of future customers. The questions Q1 306, Q2 308, Q3 310, and Q4 312 are directed to identify or classify customer prospects based on existing customers, and to train the AI sales technology stack prospecting model 122. An example of Q1 306 is “Who are your best customers?” and the features of Q1 306 can be the following: customer size, decision maker, growth from previous year, etc. An example of Q2 308 is “Why did they become customers” and the features of Q2 308 can be the following: location, first reference, etc. An example of Q3 310 can be “Why do they still buy from you” and the features of Q3 310 can be the following: customer service, product features, etc. An example of Q4 312 can be “Why do prospective customer choose the product/service over other similar products/services?”, and the features of Q4 312 can be the following: on-time delivery, service, features, etc.

The questions of input layer 300 are provided to hidden layers 302. Hidden layers 302 include multiple layers H1 314, H2 316, H3 318, H4, 320, and H5 322. It is to be understood that there can be fewer or more hidden layers. The feature based questions Q1 306, Q2 308, Q3 310, and Q4 312 provide input to particular hidden layers H1 314, H2 316, H3 318, H4, 320, and H5 322 as shown in FIG. 3. In certain implementations, hidden layers H1 314, H2 316, H3 318, H4, 320, and H5 322 are connected to one another. In general, a hidden layer is a layer between input and output layers. Artificial neurons receive a set of weighted inputs (i.e., feature based questions Q1 306, Q2 308, Q3 310, and Q4 312) and produce an output (i.e., target layer 304).

In this example, the output of the hidden layers 302 is output or target layer 304. As discussed, the target layer 306 includes various time classifications that classify existing customers. In this example, classification is made as to customers that would be converted in a least amount of time represented by least “324”, customers that would be converted in an average amount of time represented by medium “326”, customers that would be converted in a maximum amount of time as represented by maximum “328”, and customers that would not be converted as represented by no convert “330.”

Referring back to FIG. 2, in an implementation, training is performed by customer RNN 124 for the AI sales technology stack prospecting model 122 using data or information of past or current customers 202 as described FIG. 2. When the AI sales technology stack prospecting model 122 is trained, data or information of potential or future customers 214 is received by customer RNN 124 to predict a target classification of the potential or future customer 214. Examples of data or information of potential or future customers 214 can include “customer size”, “person is decision maker”, “growth the past year,” “location”, “on time delivery”, “price”, etc.

As an example, a prospective potential or future customer 214 may be classified by customer RNN 124 as “least” (i.e., target “least 324 of FIG. 3). Such a classification can indicate that the prospective potential or future customer 214 would be a very good candidate to sell the product or service. In contrast, if a prospective potential or future customer 214 is classified by customer RNN 124 as “no convert” (i.e., target “no convert” 330 of FIG. 3), then it may not be worth the effort and resource to pursue that potential or future customer 214. Once the customer RNN 124 classifies the prospective potential or future customer 214, a sales process and sales pipeline can be created for the particular potential or future customer 214. Such a sales process and sales pipeline provide recommended information as to actions a salesperson can take to close a sale with the particular potential or future customer 214.

In certain implementations, training is performed by LSTM RNN 126 for the AI sales technology stack prospecting model 122. The training is based on past sales processes and sales pipelines from pastor current customers 202.

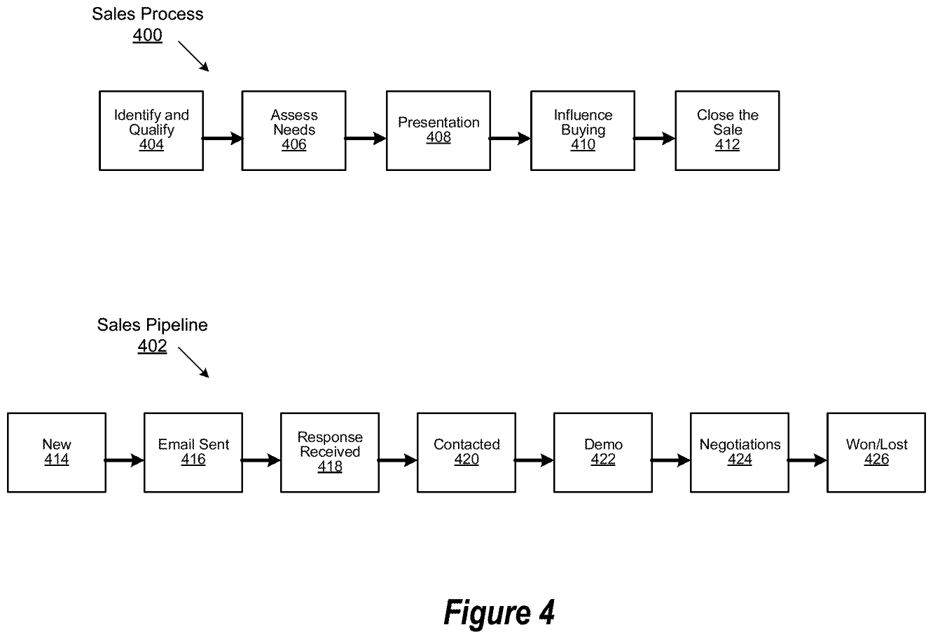

FIG. 4 shows an example of a sales process 400 and a sales pipeline 402, which are applicable to past or current customers 202 and potential or future customers 214. The steps of sales process 400 and a sales pipeline 402 are in successive order.

Sales process 400 includes the step of identifying and qualifying a customer 404. Accessing needs of the customer is performed at step 406. Presentation of the product or service is performed at step 408. Actions to influence buying are performed at step 410. The sale is closed at step 412.

Sales pipeline 402 can be specific to a customer. A new customer is identified at step 414. An initial email is sent at step 416. A response is received back from the customer at step 418. The customer is contacted at step 420. A demonstration on the product or service is performed at step 422. Negations with the customer is performed at step 424. The sales campaign with the customer is either won or lost at step 416.

As discussed, the AI sales technology stack prospecting model 122 is trained through the LSTM RNN 126 based on sales processes and sales pipelines, such as sales process 400 and sales pipeline 402. Current action in a sales process or sales pipeline is dependent on an action that is previous performed and the response of that previous action. As example, the following sales pipeline is performed specific to a customer. At time “t−9” an email is sent; at time “t−8” a response has not been received; at time “t−7” a reminder email is sent to the customer; at time “t−6” a response is received from the customer”; at time “t−5” a conversation takes place with the customer; at time “t−4” priorities are learned; at time “t−3” the decision maker is contacted; at time “t−2” a solution is demoed; at time “t−1” proposals are provided; and at time “t” objections are raised. Certain actions of the example sales pipeline are do not influence or are not dependent on the final outcome. In this action, such actions are at time “t−7” a reminder email is sent to the customer, and at time “t−5” a conversation takes place with the customer. The AI sales technology stack prospecting model 122 “forgets” such actions. In particular, the LSTM RNN 126 forgets such actions.

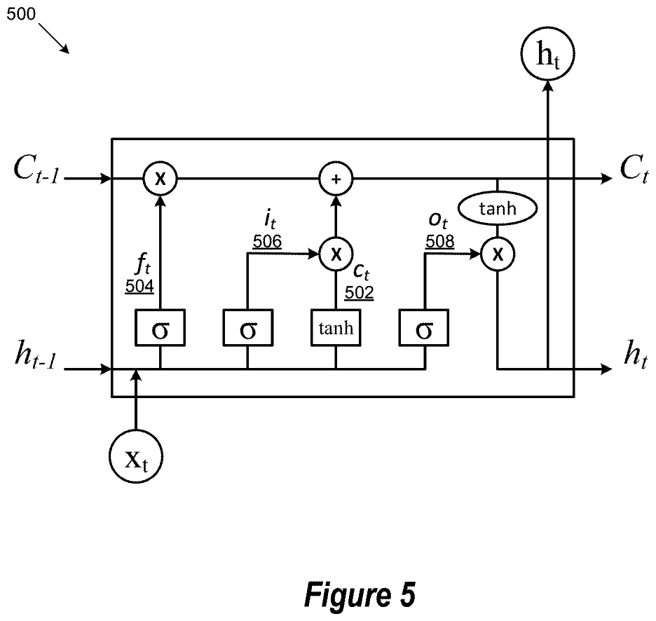

FIG. 5 shows an example of a cell 500 of the LSTM RNN 126, and how actions area processed such a cell 500. The value “t” is a time. The value “t−1” represents an action from a preceding cell. The value “X” represents a current input state at time “t”. An example of action is “conversation with customer” or Xₜ can represent new information, “conversation with customer”. The value “h” is previous output state at time “t−1”. An example of an action is “response received from customer”. For example, at hi, an output is “learned priorities”. The value “C” or input C, 502 is state of cell which remembers past whole sequences until “t−1”. Examples of actions are email sent, reminder email, response, etc. The value f or input fₜ 504 is forgotten, or information that is forgotten. In others, as described above actions that the AI sales technology stack prospecting model 122 forgets. The value iₜ 506 is an input gate value that collects current state and “t−1” hidden state and saves to cell state “C” (i.e., update state of cell 500). For example, updating “C” with conversations. The input oₜ 508 is an output state to be passed to the next “t+1” action. An example is learning company priorities.

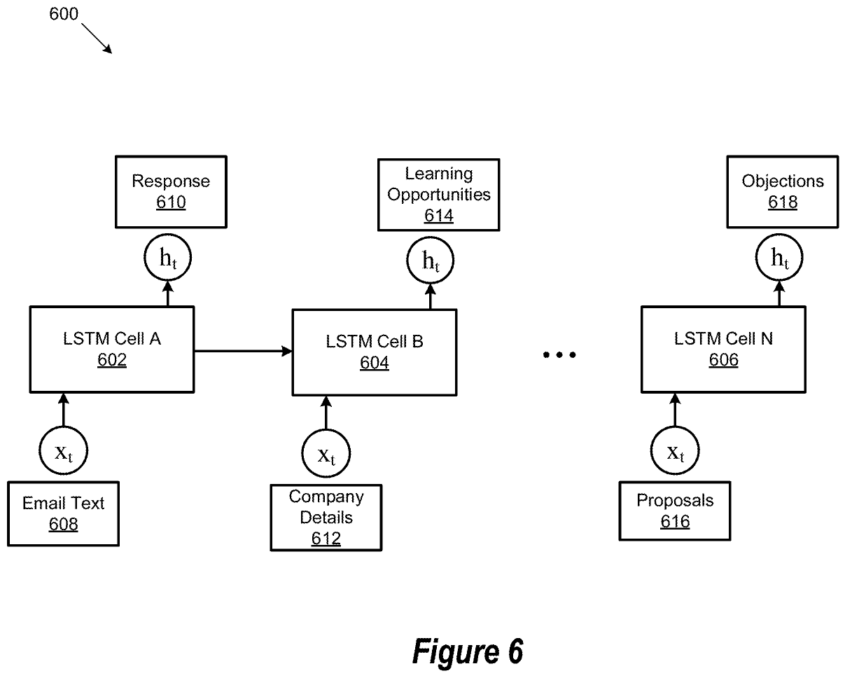

FIG. 6 shows an example sales pipeline as determined by AI sales technology stack prospecting model 122. In particular, the LSTM RNN 126 determines an overall sales pipeline (process) 600. Actions are processed by LSTM cell A 602, LSTM cell B 604 to LSTM cell N 606 which are part of the LSTM RNN 126. LSTM cell A 602, LSTM cell B 604 to LSTM cell N 606 have an input state or new information, Xₜ, and an output state hi. The AI sales technology stack prospecting model 122, and particularly the LSTM RNN 126 is trained based on past customer sales pipeline activities to understand the patterns. In this example, an input action “email text” 608 is received at LSTM cell A 602 and an output action “response” is determined by LSTM cell A 602. An input action “company details” 612 is received at LSTM cell B 604 and an output action “learning opportunities” is determined by LSTM cell B 604. An input action “proposals” 618 is received at LSTM cell N 606 and an output action “objections” is determined by LSTM cell N 606.

Therefore, using the determined overall sales pipeline 600 as learned from existing customer patterns, during prospective customer activities data feeding, the expected outcome or output for every action the sales process or pipeline can be identified in advance to better understand opportunities to convert the prospective customer.

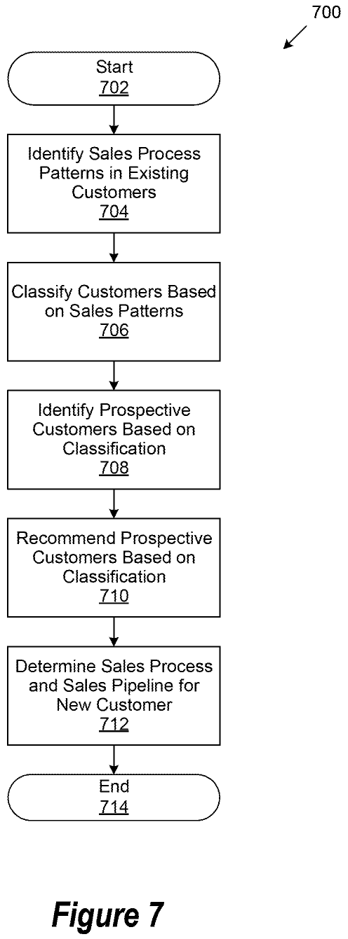

FIG. 7 is a generalized flowchart 700 of the performance of operations implemented in accordance with an embodiment of the invention for artificial intelligence (AI) sales technology stack prospecting. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 702, the process 700 starts. At step 704, sales process patterns of existing customers are identified. In certain implementations, the customer RNN 124 of the AI technology stack prospecting model 122 as described above learns the patterns, including actions of sales processes and sales patterns of existing customers, such as the current customers 202.

At step 706, customers are classified based on the sales patterns that are identified. In certain implementations, the customer RNN 124 of the AI technology stack prospecting model 122 performs the classification. Certain embodiments provide for a classification based on the time customers transition from prospective customer to actual customer. As describe above, the RNN 124 can train as to existing customers in determining classification.

At step 708, prospective customers are identified based on the classification. In certain implementations, data or information of sales patterns as to prospective customers are received by the RNN 124, and the prospective customers are classified.

At step 710, prospective customers are recommended based on classification. As described above, the prospective customers can be prioritize based on the amount of time expected to convert the prospective customer into an actual customer as per the described classification. In certain implementations, recommendation generator 128 described above provides the recommendation.

At step 712 determination is performed as to a recommended customer as for a sales process and sales pipeline. As described above, the determination of sales process and sales pipeline includes determining proactive actions that can be taken in sales process and sales of the recommended customer. In certain implementations, as described above, the LSTM RNN 126 performs learning based on existing customers and provides proactive recommendations as to prospective customers. In certain implementations, recommendation generator 128 described above provides the recommendation.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for sales prospecting, comprising:
identifying sales patterns of existing customers;
classifying the existing customers based on the sales patterns;
identifying prospective customers based on the classifying;
recommending prospective customers based on the identifying; and
determining sales processes and sales pipelines of recommended prospective customers.

2. The method of claim 1, wherein a recurring neural network (RNN) performs the identifying by learning the sales patterns of existing customers.

3. The method of claim 1, wherein a recurring neural network (RNN) performs the classification based on expected time to convert a prospective customer to an actual customer.

4. The method of claim 1, wherein the identifying is based on sales patterns received by a recurring neural network (RNN).

5. The method of claim 1, wherein recommending is performed by recommendation generator.

6. The method of claim 1, wherein the recommending prioritizes prospective customers that are most likely to convert to actual customers.

7. The method of claim 1, wherein the determining sales processes and sales pipelines is performed by a long short term memory recurring neural network (LSTM RNN).

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for improving sales prospecting executable by the processor and configured for:
identifying sales patterns of existing customers;
classifying the existing customers based on the sales patterns;
identifying prospective customers based on the classifying;
recommending prospective customers based on the identifying; and
determining sales processes and sales pipelines of recommended prospective customers.

9. The system of claim 8, wherein a recurring neural network (RNN) performs the identifying by learning the sales patterns of existing customers.

10. The system of claim 8, wherein a recurring neural network (RNN) performs the classification based on expected time to convert a prospective customer to an actual customer.

11. The system of claim 8, wherein the identifying is based on sales patterns received by a recurring neural network (RNN).

12. The system of claim 8, wherein recommending is performed by recommendation generator.

13. The system of claim 8, wherein the recommending prioritizes prospective customers that are most likely to convert to actual customers.

14. The system of claim 8, wherein the determining sales processes and sales pipelines is performed by a long short term memory recurring neural network (LSTM RNN).

15. A non-transitory, computer-readable storage medium embodying computer program code, the computer program code comprising computer executable instructions configured for:
identifying sales patterns of existing customers;
classifying the existing customers based on the sales patterns;
identifying prospective customers based on the classifying;
recommending prospective customers based on the identifying; and
determining sales processes and sales pipelines of recommended prospective customers.

16. The non-transitory, computer-readable storage medium of claim 14, wherein a recurring neural network (RNN) performs the identifying by learning the sales patterns of existing customers.

17. The non-transitory, computer-readable storage medium of claim 14, wherein a recurring neural network (RNN) performs the classification based on expected time to convert a prospective customer to an actual customer.

18. The non-transitory, computer-readable storage medium of claim 14, wherein the identifying is based a sales patterns received by a recurring neural network (RNN).

19. The non-transitory, computer-readable storage medium of claim 14, wherein the recommending prioritizes prospective customers that are most likely to convert to actual customers.

20. The non-transitory, computer-readable storage medium of claim 14, wherein the determining sales processes and sales pipelines is performed by a long short term memory recurring neural network (LSTM RNN).
